(19) United States
(12) Patent Application Publication
(10) Pub. No.: US 2025/0034899 A1
(43) Pub. Date: Jan. 30, 2025

(54) ROOFTOP TENT ASSEMBLY FOR VEHICLES

(71) Applicant: Samuel MAY, Minlaton (AU)

(72) Inventor: Samuel MAY, Minlaton (AU)

(21) Appl. No.: 18/782,547

(22) Filed: Jul. 24, 2024

(30) Foreign Application Priority Data
Jul. 24, 2023 (AU) 2023902348

(51) Int. Cl. E04H 15/06; E04H 15/44; E06C 1/12

(52) U.S. Cl. CPC E04H 15/06; E04H 15/44; E06C 1/125

(57) ABSTRACT

A rooftop tent assembly for vehicles having a base affixed to a rooftop of a vehicle, an extension plate connected to one end of the base as to overlap the base. The rooftop tent assembly has a cover affixed to the other end of the base and the cover is conceals the rooftop assembly. The rooftop assembly also has a latter affixed to a top portion of the extending plate to allow a user to deploy the rooftop tent assembly. The rooftop assembly further has an internal seal system to prove a water-tight and dust-proof seal. A pair of windows located on either side of the rooftop assembly and a window shade on each of the pair of windows held in place through one or more ropes.

### TECHNICAL FIELD

The present invention generally relates to a rooftop tent assembly. In particular, the invention relates to a rooftop tent assembly equipped with windows comprising window shades, and further, a mechanism for easy deployment of the vehicle rooftop tent along with its accompanying window and window shades.

### BACKGROUND ART

Vehicular rooftop tents have gained significant popularity due to their inherent convenience and ability to enhance the camping experience of a user by providing an elevated platform. These tents offer users a hassle-free setup process and the freedom to camp at diverse locations, while providing the same level of protection from the elements as a traditional tent, while also benefitting from the transportability of the tent.

Existing tents with windows pose certain challenges as they require additional setup for the window shades, thereby increasing the time and effort required by users. This additional step in the assembly process can be time-consuming and may introduce complexities that could potentially frustrate users. Moreover, the need to install the window shades separately adds to the overall setup procedure, which can be cumbersome and detract from the overall camping experience. Additionally, this additional setup requirement may also result in a bulkier and heavier tent, affecting its portability and ease of transportation. Consequently, there is a clear need for a more streamlined and user-friendly solution that integrates window shades into the tent assembly, eliminating the need for separate setup steps and improving the overall camping experience.

Prior art US Publication No. Us 2022/0396967 A1 discloses a vehicular rooftop tent comprising windows and window shades. However, the window shades of the disclosed tent must be manually configured, adding to the list of actions the user must remember, and presenting another point of failure. Prior art AU 2022268300 A1 discloses a vehicular rooftop tent comprising windows, however, the rooftop vehicle similarly lacks automatically deployed window shades that sufficiently prevent sunlight and the ingress of water into the tent.

It is therefore an object of this invention to provide an improved vehicular rooftop tent comprising windows with window shades, or at least provide the public with a useful alternative.

### SUMMARY OF THE INVENTION

In a first aspect the invention comprises a rooftop tent assembly for vehicles, comprising a base configured to be affixed to a rooftop of a vehicle; an extension plate securely and hingedly connected to one end of the base plate so as to overlap with the base plate; a cover hingedly affixed to another end of the base, wherein the cover is configured to conceal the rooftop tent assembly; a ladder securely affixed to a top portion of the extension plate using one or more fasteners, wherein the ladder is configured to enable a user to deploy the rooftop tent assembly by pulling down on the ladder thereby deploying a tarp over the base and extension plate; an internal seal system comprising a gasket applied around an outer perimeter the cover, wherein when the cover is closed the gasket is compressed between the cover and base plate, providing a water-tight and dust-proof seal; a pair of windows located on either side of the rooftop tent assembly, wherein each window comprises a window shade extending outwards from both sides and top of the window; and wherein each window shade is held in place through one or more ropes, wherein when the vehicle is deployed the one or more ropes are pulled into tension, raising the window shade located above the window. attached at one end to one of the window shades, extends across the width of the tent assembly, and is attached at the other end to the other window shade.

In an embodiment the one or more ropes are attached at one end to one of the window shades, extends across the width of the tent assembly, and is attached at the other end to the other window shade.

In an embodiment the one or more ropes are attached at one end to the window shades and extends across the length of the tent assembly.

In an embodiment the tarp further comprises a first interior tarp and a second exterior tarp.

In an embodiment the one or more tension ropes extend over the first interior tarp and underneath the second exterior tarp.

In an embodiment the base and the extension plate are provided with a mattress.

In an embodiment the ladder is a telescopic extendable and collapsible ladder.

In an embodiment the gasket is a rubber seal.

In an embodiment the base is affixed to the rooftop of the vehicle using one or more fasteners

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a perspective view of the vehicular rooftop tent in a closed state;

FIG. 2 is a rear view of the vehicular rooftop tent in a closed state;

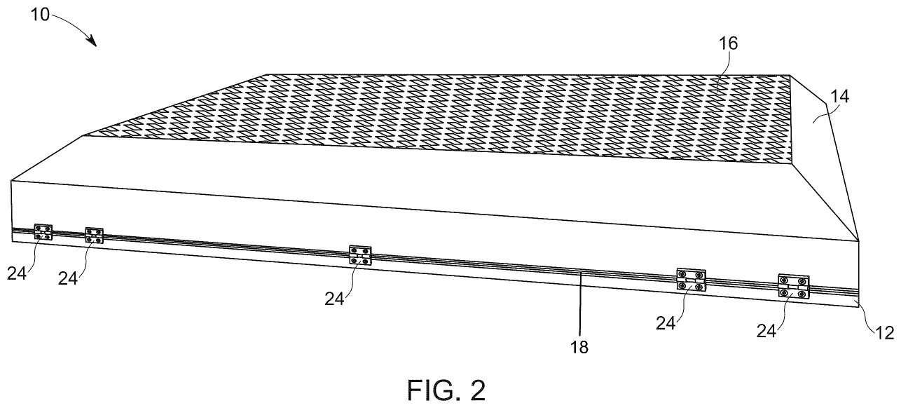

FIG. 3 is a perspective view of the vehicular rooftop tent in a partially open state;

FIG. 4 is another perspective view of the vehicular rooftop tent in a partially deployed state;

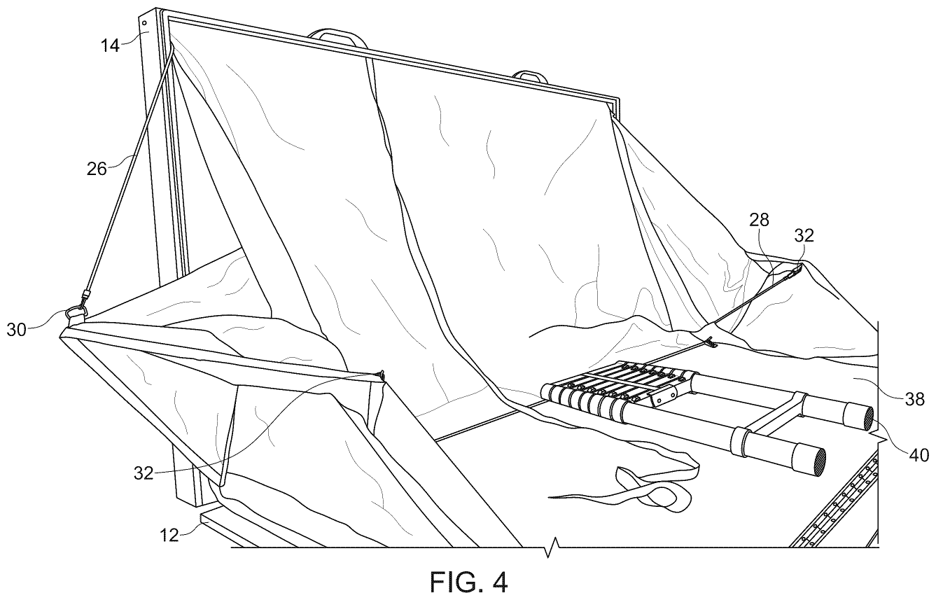

FIG. 5 is a perspective view of the vehicular rooftop tent in another partially deployed state; and

FIG. 6 is a perspective view of the vehicular rooftop tent when deployed; and

FIG. 7 is a perspective view of another embodiment of the tent when deployed.

### DETAILED DESCRIPTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

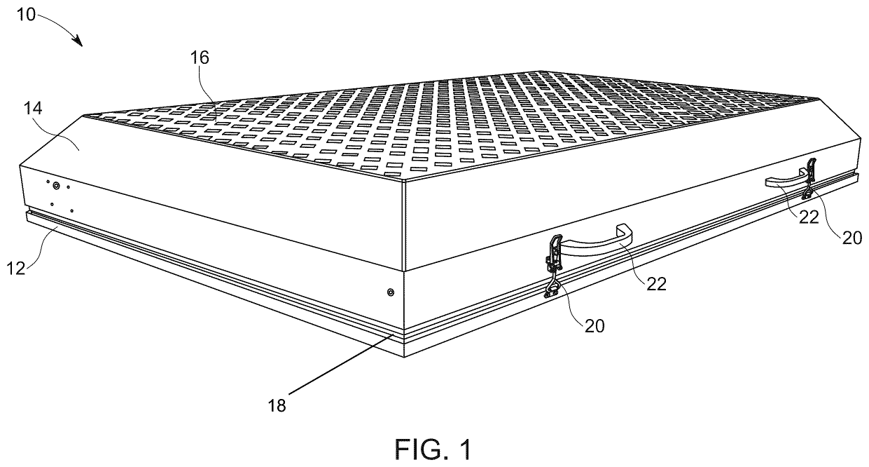

Referring to FIG. 1, a vehicular rooftop tent assembly 10 in a closed state according to an embodiment of the invention is depicted. The tent assembly 10 is configured to be easily affixed to the rooftop of a vehicle, and when deployed provides an area sufficient to allow for one or more persons to lie down within the tent. In one embodiment, the tent assembly 10 comprises a bottom plate 12, a cover 14 with tread plate 16 integrally formed into the cover. The bottom plate 12 may be affixed to the roof of a vehicle using methods known in the art, such as but not limited to using one or more fasteners.

In one embodiment, the cover 14 is securely affixed to an end of the base 12 through a plurality of hinges 24. The latches 20 located on the other end of the base may be latched or unlatched allowing the handles 22 to facilitate opening and closing of the cover 14. The contour of the cover 14 is smooth, reducing drag, wind noise, and undesired lift forces when the vehicle which the tent assembly is affixed upon is in motion. The cover 14 and base 12 may be constructed from but not limited to, aluminium, titanium, stainless steel, ABS plastics, fibre glass, and carbon fibre.

The cover portion 14 comprises a sealing system 18 which extends around the perimeter of the cover. When the cover is closed, the sealing system 18 is in contact with the base 12 and forms a waterproof seal preventing ingress of dust water into the interior of the rooftop tent assembly 10. The seal system between the top cover 14 and base of the base 12 functions by utilising a rubber gasket and compression. The rubber gasket, made of flexible materials such as but not limited to silicone or EPDM, is placed on the top cover. When the top cover is closed the gasket is compressed against the base 12 creating a tight seal. This seal effectively prevents the entry of moisture, dust, air, or contaminants, ensuring the protection and integrity of the tent assembly interior.

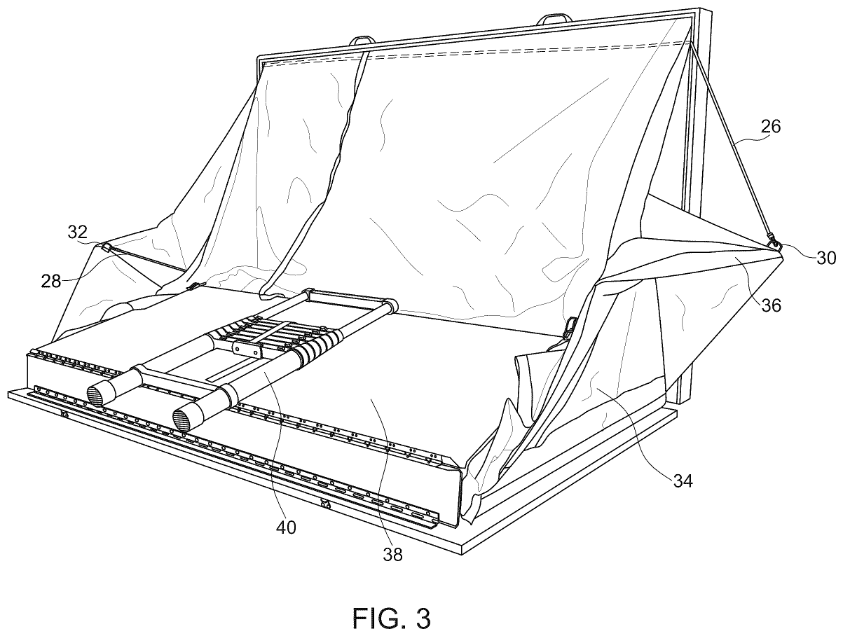

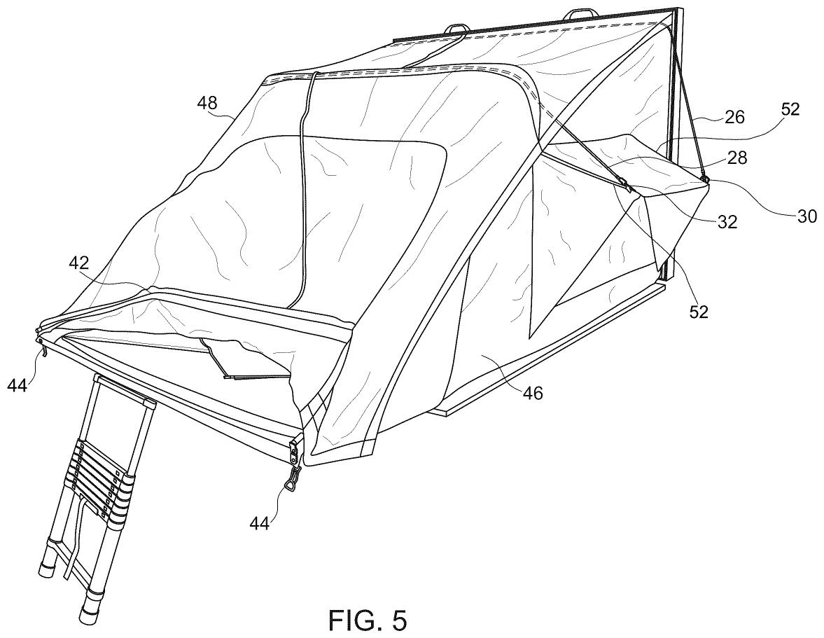

Referring to FIG. 3, the rooftop tent assembly 10 is illustrated in a partially open state according to an embodiment of the invention. An extension plate 38 is illustrated securely and hingedly connected to an end of the base 12 so as to overlap with the base 12. In an embodiment, the extension plate 38 is provided with a mattress (not shown) such that when the extension plate is opened, the mattress is accessible for use by the user. In one embodiment, a ladder 40 is securely affixed to a top portion of the extension plate 38 using methods known in the art, such as but not limited to fasteners. The ladder 40 is configured to enable a user to fully open the tent assembly 10 by pulling the ladder 40 downwards, and adjusting until the extension plate 38 is aligned to the base 12, thereby positioning a tent tarp portion 46, 48 (shown in FIG. 5) over the base 12 and the extension plate 38, providing a sheltered area for one or more users. In one embodiment, the ladder 40 could be, but not limited to a telescopic extendable and collapsible ladder.

When the rooftop tent assembly is transitioned from its closed configuration to its partially opened configuration, window shades 36 located above and around windows 34 on either side of the tent automatically extend outwards. When transitioning the rooftop tent assembly from its closed configuration to its partially opened configuration, the window shades 36 positioned above and around the windows 34 on both sides of the tent extend outward automatically. This extension is achieved by pulling a tension cable 26, which is attached to a hook 30 located at the end of the window shade, along the horizontal length of the rooftop tent assembly 10.

A plurality of rods 52 within the window shades are pulled taut as the tent assembly is deployed. As the tension in the cable causes the window shade 36 to become taut, effectively extending it outward, rods 52 contact against the now taut canvas on side walls of the tent assembly, thereby maintaining window shades 36 in a deployed position, thereby forming a stable window and window shade structure.

When the ladder 40 is pulled downward, the extension plate 38 rotates and aligns with the base 12, allowing the rooftop tent assembly 10 to transition into a fully open configuration (as shown in FIG. 5). Simultaneously, as the extension plate 38 rotates, another tension rope 28 attached to a hook 32 on the opposite end of the window shade 36 becomes taut. This tension rope 28 extends along the length of the rooftop tent assembly 10, connecting with the window shade 36 on the opposite side of the tent assembly 10. Consequently, both window shade 36 located on either side of the tent assembly 10 are pulled taut at the same time. The window shades are automatically pulled taut as a result of deploying the rooftop tent assembly 10, requiring no additional user input to configure. The window shades 36 when fully taut extend outwardly from the sides and top of the window 34, preventing rain or dust from falling upon the window 34 and entering the tent.

Additionally, as the rooftop tent assembly 10 transitions to its deployed state, the fabric tarp or canopy, connected to both the base 12 and cover 14 of the tent is tensioned to create a spacious area for one or more users. In an embodiment, the tarp comprises of two layers, an interior tarp 46 and an exterior tarp 48, which together provide durability and protection against weather elements. These tarps are typically constructed using commonly employed materials such as but not limited to polyester, polycotton canvas, and nylon, and are specifically designed to withstand various weather conditions including rain, wind, and UV rays. To enhance their resistance to water and UV damage, the fabric of the tarps may be coated or finished with suitable treatments that are well-known in the field.

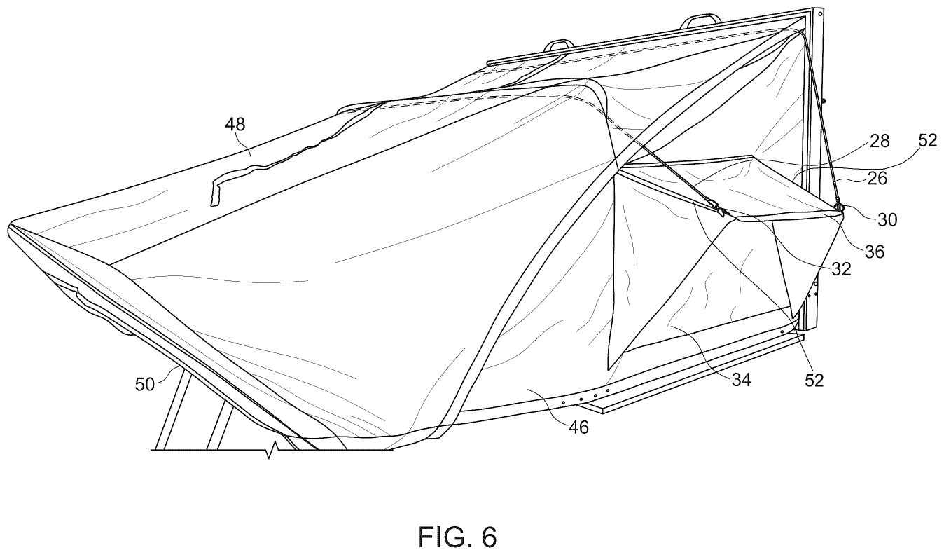

It should be noted that in an embodiment, the tension ropes 26, 28 which automatically prop up window shades 36 on both sides of the tent extend across the end width of the tent (see FIG. 6). In an embodiment, the tension ropes extend over the top of the first interior tarp 46, and underneath the second exterior tarp 48.

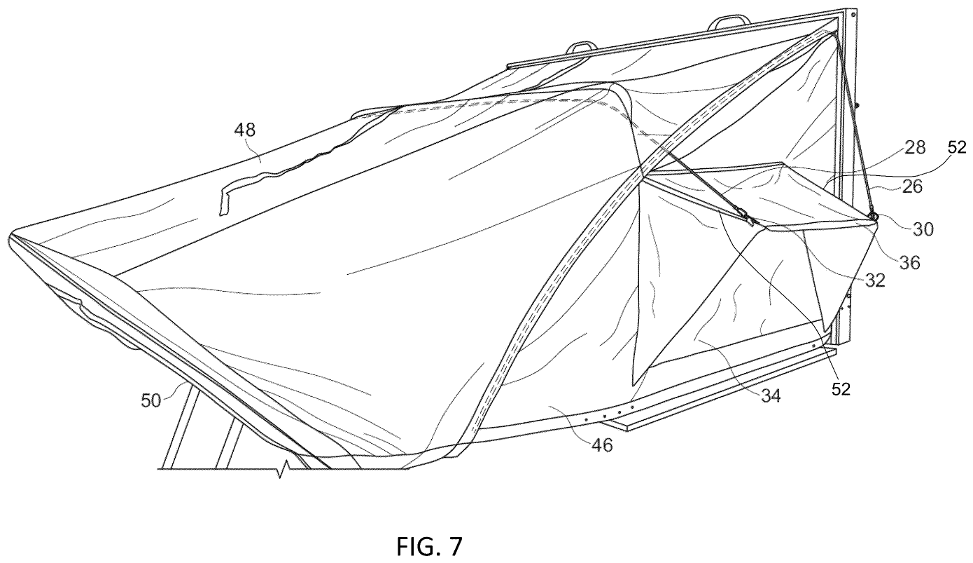

In another embodiment of the invention, the tension rope 26 attached to either side of the rear side of the window shade 36 extends along the length of the tent as depicted in FIG. 7. In this embodiment the tent comprises two tension ropes 26 located and attached to the rear side of the window shade on either side of the tent. Each tension rope 26 may be held by being stitched in a pocket along the tent extending along the length of said tent.

In order to completely deploy the tent assembly, as depicted in FIG. 6, users can simply pull open the entrance 50 to facilitate convenient entry and exit to the tent. In an embodiment, the perimeter of the entrance 50 may be equipped with zippers (not pictured) allowing protection from the surroundings. This user-friendly design ensures campers can swiftly and effortlessly access the tent, enhancing convenience and efficiency during camping expeditions.

The rooftop tent assembly 10 disclosed herein eliminates the need for supplementary setup, such as poles or stabilising elements, to maintain the tent in an upright position. Its innovative automatic deployment mechanism for the window shades 36 offers users a seamless and convenient solution, enhancing overall usability and user experience.

It is to be understood that the invention is not to be limited to any particular angle of opening. The rooftop tent may only open substantially 45 degrees as a ‘clamshell’ type tent, which is known in the art. The rooftop tent may open substantially greater than 45 degrees as is illustrated in the Figures, or any suitable angle as is known in the art.

In an embodiment of the invention, the tent may instead of being affixed to a rooftop of a vehicle be affixed to some other suitable structure, such as but not including standalone structures, trailers, a caravan, canopies and the like. The invention is not to be limited to being affixed to a rooftop of a vehicle, but may instead be affixed to any sufficiently sturdy structure or even standalone.

In an embodiment of the invention, there may not be provided a solid base to be affixed to an existing structure. Rather, the tent assembly minus the base may be directly affixed to the rooftop of a structure such as a trailer, canopy, caravan, and the like, forming an integrally affixed tent structure on said structure.

In an embodiment of the invention, the cover may not be formed from a rigid material such as metals, but rather a flexible cover may instead be used while still providing automatic pop-out windows on the tent. Said flexible cover may be formed from but not limited to canvas, synthetic fibres, burlap, and the like. Such flexible covers are capable of preventing ingress of unwanted environmental factors into the tent.

In an embodiment of the invention, the windows may instead be manually pulled taut. Instead of the rope being fixed, the interior of the tent may comprise fixed points which a user may attach a manually pulled taut rope to. This embodiment of the invention allows for increased flexibility by the user as to whether the windows should be opened. This embodiment prevents the ropes, and thereby windows, from automatically being pulled into tension.

It is to be understood that embodiments of the invention may not require a ladder to be pulled in order to deploy the tent. Those skilled in the art would recognise that the ladder simply provides a handle means for the user to grip and deploy the tent, however, such handle means are not necessary as the user may directly grip panels of the tent to deploy said tent.

It is to be understood that the invention is not to be limited to a particular style of tent. Varying different forms of tents known in the art, such as but not limited to clamshell type tents, multi-floored tents, standalone tents, and the like may incorporate the inventive windows which are automatically pulled taut as the tent is deployed.

The reader will now appreciate the present invention which provides an improved rooftop tent assembly for vehicles comprising windows with window shades that is convenient to deploy and presents the user with an attractive camping experience.

### LIST OF COMPONENTS

The drawings include the following integers:
10 rooftop tent assembly
12 bottom plate
14 cover
16 tread plate
18 sealing system
20 latches
22 handle
24 hinge
26 first tension rope
28 second tension rope
30 first rope attachment loop
32 second rope attachment loop
34 veiled window
36 window shade
38 extension plate
40 ladder
42 entrance cover
44 entrance cover securing latch
46 first interior tarp
48 second exterior tarp
50 tent entrance
52 rod

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A rooftop tent assembly for vehicles, comprising:
a base configured to be affixed to a rooftop of a vehicle;
an extension plate securely and hingedly connected to one end of the base so as to overlap with the base plate;
a cover hingedly affixed to another end of the base, wherein the cover is configured to conceal the rooftop tent assembly;
a ladder securely affixed to a top portion of the extension plate using one or more fasteners, wherein the ladder is configured to enable a user to deploy the rooftop tent assembly by pulling down on the ladder thereby deploying a tarp over the base and extension plate;
an internal seal system comprising a gasket applied around an outer perimeter of the cover, wherein when the cover is closed the gasket is compressed between the cover and base, providing a water-tight and dust-proof seal;
a pair of windows located on either side of the rooftop tent assembly, wherein each window comprises a window shade extending outwards from both sides and top of the window; and
wherein each window shade is held in place through one or more ropes, wherein when the tent is deployed the one or more ropes are pulled into tension, raising the window shade located above the window.

2. The rooftop tent assembly of claim 1, wherein the one or more ropes are attached at one end to one of the window shades, extends across the width of the tent assembly, and is attached at the other end to the other window shade.

3. The rooftop tent assembly of claim 1, wherein the one or more ropes are attached at one end to the window shades and extends across the length of the tent assembly.

4. The rooftop tent assembly of any of claim 1, wherein the tarp further comprises a first interior tarp and a second exterior tarp.

5. The rooftop tent assembly of claim 4, wherein the one or more tension ropes extend over the first interior tarp and underneath the second exterior tarp.

6. The rooftop tent assembly of claim 1, wherein the base and the extension plate are provided with a mattress.

7. The rooftop tent assembly of claim 1, wherein the ladder is a telescopic extendable and collapsible ladder.

8. The rooftop tent assembly of claim 1, wherein the gasket is a rubber seal.

9. The rooftop tent assembly of claim 1, wherein the base is affixed to the rooftop of the vehicle using one or more fasteners.

10. A tent assembly, comprising:
a base;
a cover affixed to one end of the base, wherein the cover is configured to conceal the tent assembly;
wherein a user may deploy the tent assembly by opening the cover, thereby deploying a tarp over the base and extension plate;
a pair of windows located on either side of the rooftop tent assembly, wherein each window assembly comprises a window shade extending outwards from the windows; and
wherein each window shade is held in place through one or more ropes, wherein when the tent is deployed the one or more ropes are pulled into tension thereby raising the window shades located above the windows.

11. The tent assembly of claim 10, wherein the base is affixed to a supporting structure.

12. The tent assembly of claim 10, wherein the window shades comprise rigid rods that abut a canvas of the tent assembly when the tent assembly is deployed, thereby pulling the ropes into tension to keep the window shades taut.

13. The tent assembly of claim 10, wherein the base is integrally formed into a supporting structure.

14. The tent assembly of claim 10, further comprising an extension plate hingedly connected to another end of the base plate so as to overlap with the base;
wherein the extension plate is configured to enable a user to deploy the tent assembly by flipping the extension plate.

15. The tent assembly of claim 10 further comprising a ladder affixed to a top portion of the extension plate, the ladder configured to enable a user to deploy the rooftop tent assembly by pulling down on the ladder.

16. The tent assembly of claim 10, further comprising a gasket applied around an outer perimeter of the cover, wherein when the cover is closed the gasket is compressed between the cover and base, providing a water-tight seal.

17. The tent assembly of claim 10, wherein the tent assembly when deployed an angle between the cover and base is less than 90 degrees.
